(19) United States
(12) Patent Application Publication
(10) Pub. No.: US 2026/0277818 A1
(43) Pub. Date: Sep. 17, 2026

(54) CACHE FLUSH OPERATIONS

(71) Applicant: Micron Technology, Inc., Boise, ID (US)

(72) Inventors: Domenico BALZANO, Torre Annunziata (IT); Felice COSENZA, Naples (IT)

(21) Appl. No.: 19/459,989

(22) Filed: Jan. 26, 2026

Related U.S. Application Data
(60) Provisional application No. 63/773,294, filed on Mar. 17, 2025.

(51) Int. Cl. G06F 12/0891; G06F 12/0871; G06F 13/16; G06F 13/18

(52) U.S. Cl. CPC G06F 12/0891; G06F 12/0871; G06F 13/1689; G06F 13/18

(57) ABSTRACT

In some implementations, a memory system may receive a flush command indicating for the memory system to perform a flush operation on a cache of the memory system. The memory system may determine whether to delay an execution of the flush operation based at least in part on whether a condition associated with executing flush operations at the cache is satisfied. The memory system may execute the flush operation based at least in part on the condition being satisfied.

### CROSS-REFERENCE TO RELATED APPLICATION

This Patent Application claims priority to U.S. Provisional Patent Application No. 63/773,294, filed on Mar. 17, 2025, entitled “CACHE FLUSH OPERATIONS,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to cache flush operations

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIGS. 1 and 2 are diagrams illustrating examples of systems capable of cache flush operations.

FIG. 3 is a diagram of an example of cache flush operations.

FIG. 4 is a flowchart of an example method associated with cache flush operations.

### DETAILED DESCRIPTION

A memory system may be associated with a lifespan that corresponds to an amount of time the memory system is capable of storing data (e.g., within non-volatile memory arrays) reliably. In particular, an ability of a non-volatile memory array to store data reliably may gradually diminish as the non-volatile memory array undergoes program-erase cycles. The more program-erase cycles executed at the non-volatile memory array, the greater the wear on the memory cells, which may lead to increased error rates, potential data retention issues, and ultimately, the failure of the memory cells within the non-volatile memory array to store data correctly. Therefore, decreasing the quantity of program-erase cycles performed on a non-volatile memory array may in turn increase the lifespan of the non-volatile memory array.

Certain operations within memory systems may cause the memory system to execute one or more program-erase cycles at a non-volatile memory array. For example, transferring data from a cache at the memory system to the non-volatile memory array may result in a program-erase cycle being executed at the non-volatile memory array. When executed excessively or unnecessarily, these transfers may accelerate the wear-out of memory cells in the non-volatile memory array. For instance, when the ratio of write operations to transferring data from the cache is low, memory pages within the non-volatile memory array may be prematurely filled with irrelevant data (e.g., dummy data), which may in turn result in the memory system performing additional memory management operations (e.g., garbage collection operations) that may include performing additional program-erase cycles on the non-volatile memory array.

A host system may issue, to a memory system, flush commands (which may also be referred to as “synchronization commands,” or “sync cache commands”) indicating for the memory system to perform flush operations on the cache, where the memory system transfers the data from the cache to the non-volatile memory array. But if the host system issues the flush commands excessively or unnecessarily, the memory system may perform excessive or unnecessary program-erase cycles on the non-volatile memory array.

Memory systems described herein may selectively delay an execution of flush operations triggered by a host system, which may increase a lifespan of the memory system. Some implementations described herein enable the memory system to determine whether to delay the execution of the flush operation based on whether a condition associated with executing flush operations at the cache is satisfied. Accordingly, the memory system may refrain from executing flush operations until the condition is met. The condition could be tied to various factors, such as an idle time threshold, the cache being full, or the presence of high priority commands. Furthermore, the memory system may include a register to indicate pending flush commands and may refrain from executing any new flush commands if a previous flush command is already pending.

By delaying some cache flush operations, the memory system may reduce the quantity of program-erase cycles performed at the non-volatile memory array. That is, the memory system may decrease the quantity of flush operations that are performed unnecessarily, which may improve the cache utilization and preserve the integrity of the memory cells. Accordingly, the lifespan of the memory system may be extended by minimizing unnecessary wear while maintaining high performance and data reliability, thereby offering a robust solution to the challenges of current memory management practices. Additionally, reducing unnecessary wear and extending the lifespan of the memory system may be beneficial for memory systems deployed within cloud data centers, artificial intelligence or analytics applications, and gaming applications, where high performance, reduced latency, and energy-efficient storage solutions are critical.

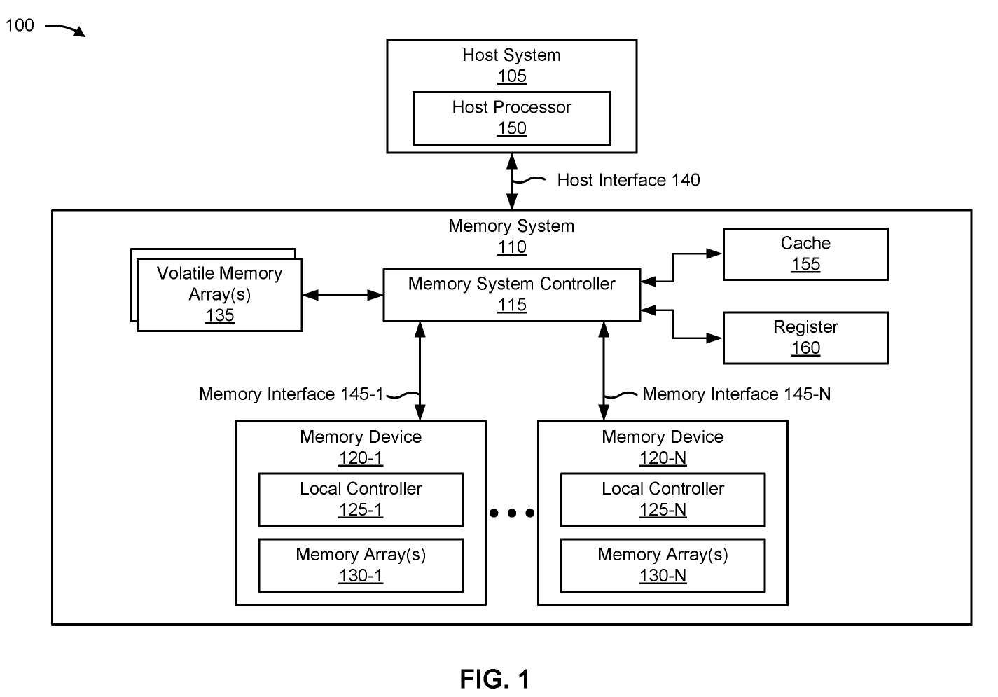

FIG. 1 is a diagram illustrating an example system 100 capable of cache flush operations. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The memory system 110 may include a cache 155, which may also be referred to as a “temporary buffer.” The cache 155 may correspond to a volatile memory array, such as the volatile memory arrays 135. The cache 155 may correspond to SRAM array. The cache 155 may temporarily store data that is frequently accessed or recently written. The memory system 110 may then use the cache 155 to execute write or read commands received from the host system 105. In particular, the memory system 110 may store data in the cache to enable faster access and lower latency (e.g., as compared to accessing data stored in a memory array 130, such as a non-volatile memory array). When the memory system 110 receives a write command from the host system 105 (e.g., via the host interface 140), the memory system 110 may write the data associated with the write command to the cache 155, which may decrease a latency associated with executing the write command as compared to the memory system 110 writing the data to a non-volatile memory array. Similarly, the memory system 110 may execute a read command by retrieving the data from the cache 155 (e.g., if the cache 155 is storing the data associated with the read command), which may decrease a latency associated with executing the read command as compared to the memory system 110 retrieving the data from a memory array 130 (such as from a non-volatile memory array).

The memory system 110 may include a register 160. In some cases, the register 160 may store an indication related to a status of the memory system 110. For example, the register 160 may store an indication related to whether there are any pending flush commands at the memory system 110 associated with the cache 155. A pending flush command may correspond to a flush command that has been received (e.g., from the host system 105) and not yet executed.

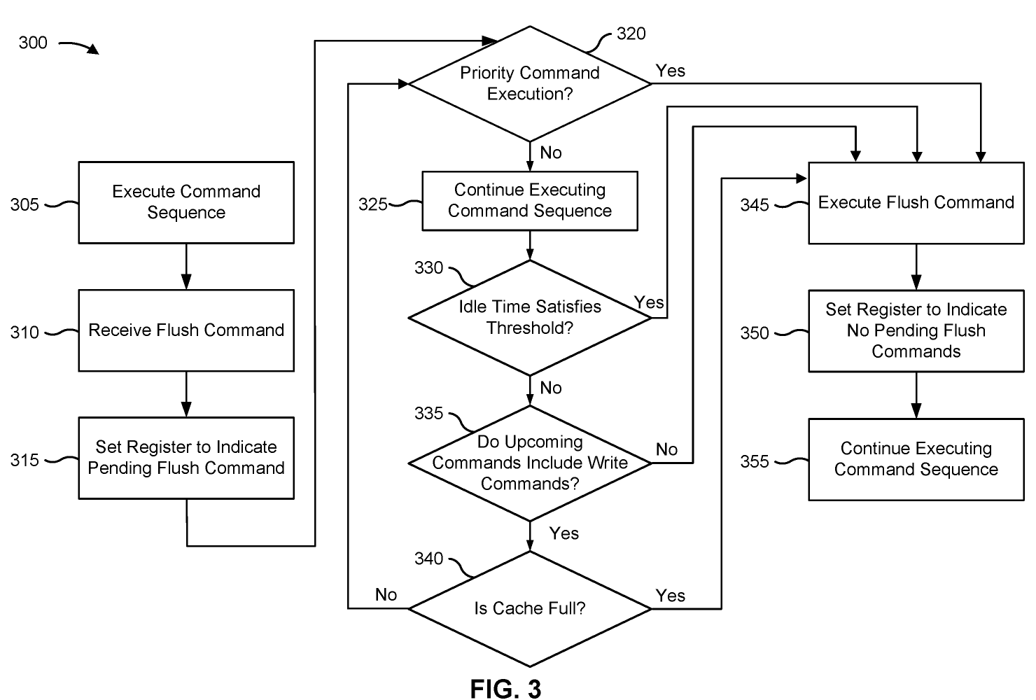

If the cache 155 becomes full or if the host system 105 issues a flush command associated with the cache 155, the memory system 110 may transfer the data from the cache 155 to a memory array 130 (such as to a non-volatile memory array). In particular, the host system 105 may provide a flush command to the memory system 110 (e.g., via the host interface 140) that indicates for the memory system 110 to transfer data from the cache 155 to a memory array 130 (such as to a non-volatile memory array). The memory system 110 may determine whether to delay the execution of the flush command based on whether a condition associated with executing the flush command is satisfied, as described in more detail with respect to FIG. 3.

If the memory system 110 determines to delay the execution of the flush command, the memory system 110 may store, in the register 160, an indication of the pending flush command (e.g., of a flush command that has been received, but not yet executed, by the memory system 110). That is, the register 160 may store an indication of whether there are any pending flush commands at the memory system 110. For example, if the register 160 is set to a first value (e.g., a ‘0’), the register 160 may be storing an indication that there are currently no pending flush commands at the memory system 110 (e.g., that there are no flush commands that have been received and not yet executed by the memory system 110). Additionally, if the register 160 is set to a second value (e.g., to a ‘1’), the register 160 may be storing an indication that there are currently one or more pending flush commands at the memory system 110 (e.g., that there are currently one or more flush commands that have been received and not yet executed by the memory system 110).

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host system 105, a flush command indicating for the memory system 110 to perform a flush operation on a cache 155 of the memory system 110; determine whether to delay an execution of the flush operation based at least in part on whether a condition associated with executing flush operations at the cache 155 is satisfied; and execute the flush operation based at least in part on the condition being satisfied.

In some other implementations, one or more systems, devices, apparatuses, components, and/or controllers of FIG. 1 may be configured to receive a synchronization command indicating for the memory system 110 to transfer data from a cache 155 to a non-volatile memory array; and transfer the data from the cache 155 to the non-volatile memory array based at least in part on receiving the synchronization command and a condition associated with a transferring of data from the cache 155 to the non-volatile memory array being satisfied.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

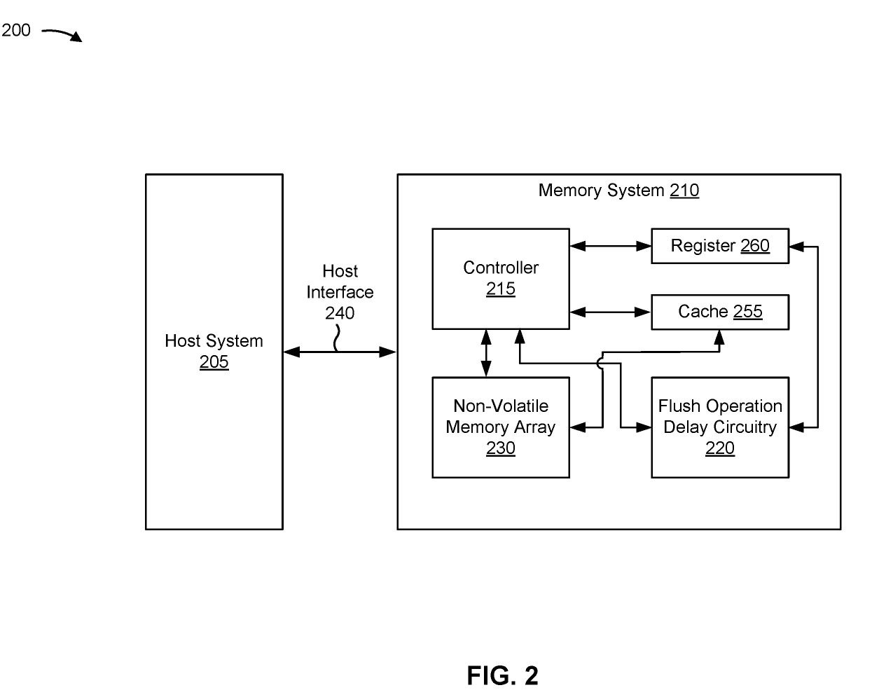

FIG. 2 is a diagram illustrating an example system 200 capable of cache flush operations. The system 200 may include aspects of the system 100 described with reference to FIG. 1. For example, the host system 205 may be an example of or include aspects of the host system 105, the memory system 210 may be an example of or include aspects of the memory system 110, and the host interface 240 may be an example of or include aspects of the host interface 140. Additionally, the controller 215 may include aspects of the memory controller 115, the non-volatile memory array 230 may include aspects of the memory arrays 130, the cache 255 may include aspects of or be an example of the cache 155, and the register 260 may include aspects of or be an example of the register 160.

The memory system 210 may be coupled to the host system 205 via the host interface 240. The memory system may include the controller 215, the non-volatile memory array 230, the cache 255, the register 260, and flush operation delay circuitry 220. In some cases, the flush operation delay circuitry 220 may be included within the controller 215. In some other cases, the flush operation delay circuitry 220 may be distinct from the controller 215.

The non-volatile memory array 230 may be included within a non-volatile memory device, such as a NAND memory device, and may use circuitry to enable electrically programming, erasing, and storing of data even when a power source is not supplied. The non-volatile memory array 230 may include multiple blocks of memory cells, and each block of memory cells may include one or more pages of memory cells. In some cases, read and program operations on the non-volatile memory array 230 may be performed according to a page-granularity (e.g., one or more pages of memory cells are read or programmed at a time), and erase operations on the non-volatile memory array 230 may be performed according to a block-granularity (e.g., one or more blocks of memory cells are erased at a time).

The controller 215 may execute access operations on the non-volatile memory array 230. Access operations on the non-volatile memory array 230 may include program, erase, and read operations. To store data, the controller 215 may execute a program operation, which may write data to a page of the non-volatile memory array 230. In some cases, a program operation may also be referred to as a write operation. Before programming new data, the controller 215 may execute an erase operation at the non-volatile memory array 230, which may reset all pages within a block to a default state. The controller 215 may execute a read operation to retrieve data from a specific page of the non-volatile memory array 230.

The memory system 210 may use the cache 255 to temporarily store frequently accessed or recently written data, enabling faster access and lower latency for read and write operations. When executing a write operation associated with an address within the non-volatile memory array 230, the controller 215 may write the data to the cache 255 first (e.g., prior to storing the data within the non-volatile memory array 230), which may reduce latency as compared to the controller 215 writing the data directly to the non-volatile memory array 230. Similarly, for read operations, the controller 215 may retrieve data from the cache 255 (e.g., if the data is stored within the cache 255), which may enable the controller 215 to retrieve the data faster than if the controller 215 retrieves the data from the non-volatile memory array 230.

The host system 205 may provide, to the memory system 210, a stream of commands via the host interface 240. For example, the host system 205 may provide or issue access commands (e.g., read commands, write commands), commands associated with a power state of the memory system 210 (e.g., power-on commands, sleep commands, power-down commands, standby commands), or other commands that indicate for the memory system 210 to perform one or more operations.

In some cases, the host system 205 may issue (e.g., may communicate, may transmit) a flush command to the memory system 210 within the stream of commands. In some cases, the flush command may also be referred to as a “sync cache command.” The flush command may indicate, to the memory system 210, to perform a flush operation on the cache 255. To execute the flush operation, the controller 215 may transfer the data from the cache 255 to the non-volatile memory array 230. In some cases, to transfer the data from the cache 255 to the non-volatile memory array 230, the controller 215 may perform a program operation or an erase operation followed by a program operation on the non-volatile memory array 230.

In a first example, the controller 215 may determine that the non-volatile memory array 230 includes one or more pages of memory cells that have been previously-erased (e.g., previously set to a default value). Here, to execute the flush command and perform the flush operation, the controller 215 may program the one or more pages of memory cells that have been previously-erased (e.g., depending on a size of the cache 255) to store the data from the cache 255. In a second example, the controller 215 may determine that the non-volatile memory array 230 does not include one or more pates of memory cells that have been previously-erased (e.g., and that are currently set to a default value). Here, to execute the flush command and perform the flush operation, the controller 215 may first erase a block of memory cells, and then may program one or more pages of memory cells within the block of memory cells to store the data from the cache 255. In both examples, to execute the flush command and perform the flush operation, the controller 215 may perform a programming operation on the non-volatile memory array 230.

To decrease a quantity of programming operations on the non-volatile memory array 230, the controller 215 may determine to delay an execution of the flush command, and refrain (e.g., for a duration) from performing the flush operation. That is, the memory system 210 may include the flush operation delay circuitry 220, which may cause the memory system 210 to delay the execution of the flush command until one or more additional conditions are met (e.g., in addition to receiving the flush command from the host system 205). As described in more detail with respect to FIG. 3, the one or more additional conditions may include whether the memory system 210 receives any other commands from the host system 205 (e.g., within a command stream) associated with transferring data from the cache 255 to the non-volatile memory array 230, whether the controller 215 determines to perform any resource management operations or other internal operations that include transferring data from the cache 255 to the non-volatile memory array 230, whether the idle time of the memory system 210 satisfies a threshold, whether at least a threshold quantity of upcoming commands within the command stream do not include a write command, or whether the cache 255 is full.

Accordingly, when the memory system 210 receives a flush command from the host system 205, the flush operation delay circuitry 220 may determine whether to execute the flush command without a delay or whether to delay the execution of the flush command. For example, if the flush operation delay circuitry 220 determines that at least one additional condition is met, the flush operation delay circuitry 220 may determine to execute the flush command and perform the flush operation. Here, the flush operation delay circuitry 220 may indicate, to the controller 215, to transfer the data from the cache 255 to the non-volatile memory array 230. Additionally, if the flush operation delay circuitry 220 determines that none of the conditions are met, the flush operation delay circuitry 220 may cause the controller 215 to delay the execution of the flush command and refrain from executing the flush operation (e.g., for a duration and until a condition is met). Then, and in response to determining that at least one of the conditions is met, the flush operation delay circuitry 220 may cause the controller 215 to execute the flush command and perform the flush operation of the cache 255 after the delay.

For example, if the flush operation delay circuitry 220 detects that none of the conditions are met for a period of time after the host system 205 issues the flush command (e.g., and detects that at least one of the conditions is met after the period of time), the flush operation delay circuitry 220 may cause the memory system 210 to refrain from executing the flush command and performing the flush operation for the period of time. Additionally, the flush operation delay circuitry 220 may cause the memory system 210 to execute the flush command and perform the flush operation after the period of time.

The register 260 may be configured to store an indication of whether there are any pending flush commands at the memory system 210. A pending flush command may correspond to a flush command that has been received from the host system 205 and not yet executed by the memory system 210. That is, a flush command may correspond to a pending flush command if the controller 215 or the flush operation delay circuitry 220 causes the memory system 210 to delay an execution of the flush command (e.g., for a duration or a period of time after receiving the flush command from the host system 205). In some cases, if the register 260 is storing a first value (e.g., a ‘0,’), the register 260 may be storing an indication that there are currently no pending flush commands at the memory system 210. Additionally, if the register 260 is storing a second value (e.g., a ‘1’), the register 260 may be storing an indication that there are currently one or more pending flush commands at the memory system 210.

In response to receiving a flush command from the host system 205, the controller 215 or the flush operation delay circuitry 220 may set the register 260 to a value indicating a presence of one or more pending flush commands at the memory system 210. If the memory system 210 receives a flush command while the register 260 is storing an indication that the memory system 210 has at least one pending flush command, the memory system 210 may refrain from executing the flush command and continue to monitor whether any of the conditions associated with executing flush commands have been met. After executing a flush command or performing a flush operation on the cache 255, the controller 215 or the flush operation delay circuitry 220 may set the register 260 to a value indicating an absence of any pending flush commands at the memory system 210.

As indicated above, FIG. 2 is provided as an example. Other examples may differ from what is described with regard to FIG. 2.

FIG. 3 is a diagram of an example 300 of cache flush operations. The operations described in connection with FIG. 3 may be performed by the memory system 110 or the memory system 210 or one or more components of the memory system 110 or the memory system 210, such as the memory system controller 115, one or more memory devices 120, one or more local controllers 125, the controller 215, the flush operation delay circuitry 220, or the non-volatile memory array 230.

At 305, the memory system may execute a command sequence. That is, the host system may communicate a set of commands to the memory system (e.g., via a host interface), and the memory system may execute the set of commands by performing the corresponding set of operations indicated by the set of commands.

At 310, the memory system may receive a flush command from the host system. That is, the command sequence may include a flush command indicating for the memory system to transfer data from a cache of the memory system (e.g., the cache 155, the cache 255) to a non-volatile memory array of the memory system (e.g., a memory array 130, the non-volatile memory array 230).

At 315, the memory system may set a register (e.g., the register 160, the register 260) to a value that indicates at least one pending flush command at the memory system 210. That is, the memory system may set the register to the value indicating the at least one pending flush command based on receiving a flush command from the host system, and not yet executing the flush command by transferring the data from the cache to the non-volatile memory array. If at 315 the register is already set to a value indicating the at least one pending flush command, the memory system may proceed to 320 without updating the register.

Then the memory system may proceed to determine whether any conditions associated with executing flush commands at the cache of the memory system are satisfied. That is, the memory system may execute one or more of the operations described with reference to 320, 325, 330, 335, and 340. While the memory system is executing the one or more operations described with reference to 320, 325, 330, 335, and 340, the memory system may be delaying the executing of the flush command and refraining for performing the flush operation on the cache of the memory system. The operations described with reference to 320, 330, 335, and 340 may correspond to the memory system determining whether any of the conditions associated with executing flush commands at the cache of the memory system are satisfied. That is, at 320, 330, 335, and 340, the memory system may either determine that a condition associated with executing flush commands is satisfied and proceed to 345 (e.g., to execute the flush command) or determine that none of the conditions associated with executing flush commands are satisfied (e.g., and continue to delay the execution of the flush command).

At 320, the memory system (e.g., using the flush operation delay circuitry 220) may determine whether the memory system is executing any priority commands. If the memory system determines that the memory system is going to execute a priority command, the memory system may proceed to 345 to execute the flush command. If the memory system determines that the memory system is not currently going to execute a priority command, the memory system may delay an execution of the flush command and proceed to 325.

The priority commands may include commands that are received from the host system and commands that are generated internally by the memory system. In some cases, the priority commands may include commands where the memory system transfers data from the cache to the non-volatile memory system as part of an execution of the command. Additionally, the priority commands may include commands associated with resource management operations at the memory system, power state changes (e.g., powering off, transitioning the memory system to operate in a lower power mode), reliability mode changes (e.g., transitioning the memory system to operate in a higher reliability mode), or other types of commands.

For example, the priority commands may include commands associated with the host system initiating a power down of the memory system. For example, if the host system communicates, to the memory system, a power off notification, the memory system may proceed to 345 (e.g., to execute the flush command prior to the memory system losing power). The power off notification may indicate, to the memory system, that a power down of the memory system is imminent. Additionally, if the host system communicates, to the memory system, a power down command, the memory system may proceed to 345 (e.g., and execute the flush command prior to executing the power down command). The power down command may correspond to a system sleep command or a system shutdown command. In some cases, if the host system communicates, to the memory system, a stand-by command, or another command indicating for the memory system to transition into a low-power mode, the memory system may proceed to 345 (e.g., and may execute the flush command prior to transitioning the memory system into the stand-by mode or low-power mode).

As another example, the priority commands may include write commands, communicated to the memory system by the host system, that indicate for the memory system to store the data associated with the write command in the non-volatile memory array without intermediate storage in a volatile memory array (e.g., such as a cache or a buffer). For example, if the host system communicates, to the memory system, a force unit access command or a reliable write command, the memory system may proceed to 345 (e.g., and execute the flush command as part of the force unit access command or as part of the reliable write command).

The priority commands may also include commands that are generated by the memory system (e.g., by a firmware of the memory system). For example, the priority commands may include commands associated with resource management operations or operations associated with freeing resources within the non-volatile memory array or other memory arrays or registers at the memory system. For example, the memory system may generate commands associated with performing a mapping removal operation (e.g., a free resource command indicating a free resource operation where one or more addresses within the non-volatile memory array are removed or invalidated), a partition switching operation (e.g., for wear leveling of the non-volatile memory array), a purge operation (e.g., associated with removing or invalidating data within one or more portions of the non-volatile memory array), a verification operation (e.g., to verify an integrity of data stored within one or more portions of the non-volatile memory array), a reset operation (e.g., at the memory system to reset one or more registers, the cache, one or more volatile memory arrays, or one or more buffers within the memory system), a discard operation (e.g., associated with freeing up blocks or pages of the non-volatile memory array), or a sanitize operation (e.g., to securely erase or clear data from one or more pages or blocks of the non-volatile memory array).

If the memory system determines to perform the mapping removal operation, the partition switching operation, the purge operation, the verification operation, the reset operation, the discard operation, or the sanitize operation, the memory system may proceed to 345 (e.g., and execute the flush command as part of the corresponding operation, prior to the performing the corresponding operation, or after performing the corresponding operation).

The priority commands may also correspond to other commands that are associated with one or more internal operations at the memory system. For example, if the memory system generates a checkpoint command associated with performing a checkpoint operation (e.g., associated with the memory system storing an image or a current state of data in the non-volatile memory array), a refresh command associated with performing a refresh operation (e.g., to maintain or restore data stored in a page or block of the non-volatile memory array), or garbage collection command associated with performing a garbage collection operation (e.g., to erase invalid data), the memory system may proceed to 345 (e.g., and execute the flush command as part of the corresponding operation, prior to the performing the corresponding operation, or after performing the corresponding operation).

At 325, the memory system may continue executing the command sequence. That is, the memory system may have received a flush command from the host system (e.g., at 310) and may have refrained from executing the flush command based on determining (e.g., by the flush operation delay circuitry) that the memory system is not executing any priority commands. Accordingly, at 325 the memory system may continue executing one or more commands received from the host system while the memory system has at least one pending flush command.

At 330, the memory system may determine whether an idle time of memory system satisfies a threshold. The idle time of the memory system may correspond to a time where the memory system is not actively executing any access operations. For example, if at 325 and while executing the command sequence, an idle time of the memory system satisfies a threshold (e.g., the idle time of the memory system is greater than or equal to the threshold), the memory system may proceed to 345. Here, the memory system may execute the flush operation during a period of time that is associated with decreased access operations at the non-volatile memory array, which may decrease a latency associated with executing the flush operation. Additionally, if at 325 and while executing the command sequence, the idle time of the memory system fails to satisfy the threshold (e.g., the idle time of the memory system is less than the threshold), the memory system may continue to delay the execution of the flush command and proceed to 335. The threshold associated with the idle time may be fixed or defined by a firmware of the memory system.

At 335, the memory system may determine whether at least a threshold quantity of upcoming commands within the command sequence do not include a write command. In particular, if while executing the command sequence at 325 the memory system determines that at least a threshold quantity of upcoming commands within the command sequence (e.g., at least a threshold quantity of upcoming commands received from the host system) do not include a write command associated with the non-volatile memory array, the memory system may proceed to 345. Additionally, if while executing the command sequence at 325 the memory system determines that the threshold quantity of upcoming commands within the command sequence do include a write command, the memory system may continue delaying the execution of the flush command and proceed to 340.

For example, if the threshold quantity of upcoming commands corresponds to five commands, the memory system may determine whether the next five commands in the command sequence include a write command. If the next five commands do include a write command, the memory system may proceed to 340. Additionally, if the next five commands do not include a write command, the memory system may proceed to 345. Accordingly, the memory system may execute the flush operation during a period of time that is not associated with any write operations to the cache or the non-volatile memory array (e.g., that are triggered by host commands), which may decrease a latency associated with executing the flush operation. The threshold associated with the quantity of upcoming commands may be fixed or defined by a firmware of the memory system.

In some cases, the conditions associated with 330 and 335 may correspond to operational conditions of the memory system.

At 340, the memory system may determine whether the cache is full. If the cache is full, the memory system may proceed to 345 and execute the flush command. Additionally, if the cache is not full, the memory system may proceed to 320. In some cases, at 340 the memory system may determine whether the amount of data stored within the cache is greater than or equal to a threshold. For example, if the memory system determines that the amount of data stored within the cache is greater than the threshold, the memory system may proceed to 345. Additionally, if the memory system determines that the amount of data stored within the cache is less than the threshold, the memory system may continue to delay the executing of the flush command and proceed to 320. Accordingly, the memory system may decrease a quantity of flush operations that are performed by refraining from executing the flush command if the cache is not full (or if the cache is storing less than a threshold amount of data).

If the memory system proceeds to 320, the memory system may continue to monitor whether any of the conditions associated with executing the flush operation on the cache are satisfied (e.g., as described with reference to 320, 330, 335, and 340).

At 345, the memory system may execute the flush command. That is, the memory system may perform the flush operation on the cache of the memory system indicated by the flush command. To perform the flush operation, the memory system may transfer the data that is stored in the cache of the memory system to the non-volatile memory array. In some cases, the transferring of the data may include the memory system performing both an erase operation at the non-volatile memory array and a program operation. In some other cases, the transferring of the data may include the memory system performing the program operation (e.g., without performing the erase operation).

At 350, the memory system may set the register (e.g., the register 160, the register 260) to a value that indicates that there are no pending flush commands at the memory system. That is, the memory system may set the register to the value indicating an absence of pending flush commands at the memory system based on executing the flush command at 345.

At 355, the memory system may continue executing the command sequence from the host system. If the memory system receives another flush command, the memory system may proceed to 315.

As indicated above, FIG. 3 is provided as an example. Other examples may differ from what is described with regard to FIG. 3.

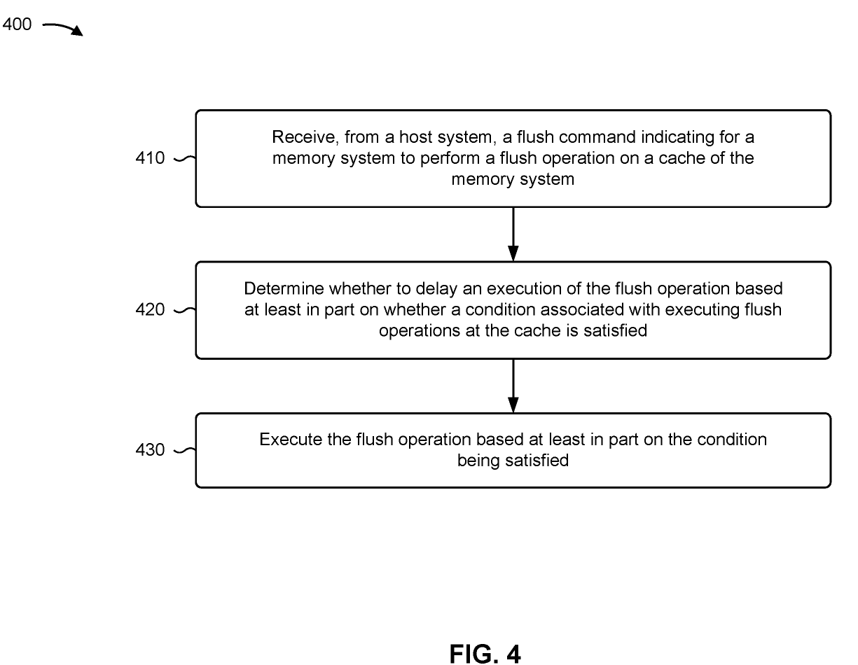

FIG. 4 is a flowchart of an example method 400 associated with cache flush operations. In some implementations, a memory system (e.g., the memory system 110, the memory system 210) may perform or may be configured to perform the method 400. In some implementations, another device or a group of devices separate from or including the memory system (e.g., the host system 105, or the host system 205) may perform or may be configured to perform the method 400. Additionally, or alternatively, one or more components of the memory system (e.g., the memory system controller 115, the memory devices 120, the cache 155, the register 160, the controller 215, the flush operation delay circuitry 220, the non-volatile memory array 230, the cache 255, or the register 260) may perform or may be configured to perform the method 400. Thus, means for performing the method 400 may include the memory system and/or one or more components of the memory system. Additionally, or alternatively, a non-transitory computer-readable medium may store one or more instructions that, when executed by the memory system, cause the memory system to perform the method 400.

As shown in FIG. 4, the method 400 may include receiving, from a host system, a flush command indicating for a memory system to perform a flush operation on a cache of the memory system (block 410). As further shown in FIG. 4, the method 400 may include determining whether to delay an execution of the flush operation based at least in part on whether a condition associated with executing flush operations at the cache is satisfied (block 420). As further shown in FIG. 4, the method 400 may include executing the flush operation based at least in part on the condition being satisfied (block 430).

The method 400 may include additional aspects, such as any single aspect or any combination of aspects described below and/or described in connection with one or more other methods or operations described elsewhere herein.

In a first aspect, the method 400 includes determining whether to delay the execution of the flush operation comprises determining to delay the execution of the flush operation based at least in part on the condition not being satisfied, and the method 400 includes refraining from executing the flush operation for a duration based at least in part on the condition not being satisfied for the duration, wherein executing the flush operation occurs after the duration.

In a second aspect, alone or in combination with the first aspect, the method 400 includes executing a priority command after receiving the flush command, wherein the condition being satisfied is based at least in part on executing the priority command.

In a third aspect, alone or in combination with one or more of the first and second aspects, the condition comprises an idle time of the memory system being greater than a threshold, and the method 400 includes executing the flush command based at least in part on the idle time of the memory system being greater than the threshold.

In a fourth aspect, alone or in combination with one or more of the first through third aspects, the condition comprises at least a threshold quantity of upcoming commands not including any write commands, and the method 400 includes executing the flush command based at least in part on at least the threshold quantity of upcoming commands not including any write commands.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

In some implementations, a memory system includes one or more components configured to: receive, from a host system, a flush command indicating for the memory system to perform a flush operation on a cache of the memory system; determine whether to delay an execution of the flush operation based at least in part on whether a condition associated with executing flush operations at the cache is satisfied; and execute the flush operation based at least in part on the condition being satisfied.

In some implementations, a memory system includes a cache; a non-volatile memory array; a host interface configured to receive a synchronization command indicating for the memory system to transfer data from the cache to the non-volatile memory array; and a controller coupled to the cache, the non-volatile memory array, and the host interface, the controller configured to transfer the data from the cache to the non-volatile memory array based at least in part on receiving the synchronization command and a condition associated with a transferring of data from the cache to the non-volatile memory array being satisfied.

In some implementations, a method includes receiving, from a host system, a flush command indicating for a memory system to perform a flush operation on a cache of the memory system; determining whether to delay an execution of the flush operation based at least in part on whether a condition associated with executing flush operations at the cache is satisfied; and executing the flush operation based at least in part on the condition being satisfied.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more components configured to:
receive, from a host system, a flush command indicating for the memory system to perform a flush operation on a cache of the memory system;
determine whether to delay an execution of the flush operation based at least in part on whether a condition associated with executing flush operations at the cache is satisfied; and
execute the flush operation based at least in part on the condition being satisfied.

2. The memory system of claim 1, wherein:
to determine whether to delay the execution of the flush operation, the one or more components are configured to determine to delay the execution of the flush operation based at least in part on the condition not being satisfied; and
the one or more components are further configured to refrain from executing the flush operation for a duration based at least in part on the condition not being satisfied for the duration, wherein executing the flush operation occurs after the duration.

3. The memory system of claim 1, wherein the one or more components are configured to:
execute a priority command after receiving the flush command, wherein the condition being satisfied is based at least in part on executing the priority command.

4. The memory system of claim 3, wherein the priority command corresponds to a power off notification, a power down command, a force unit access command, a reliable write command, a stand-by command, a free resource command, a checkpoint command, a refresh command, or a garbage collection command.

5. The memory system of claim 1, wherein the condition comprises an idle time of the memory system being greater than a threshold, and wherein the one or more components are configured to:
execute the flush command based at least in part on the idle time of the memory system being greater than the threshold.

6. The memory system of claim 1, wherein the condition comprises at least a threshold quantity of upcoming commands not including any write commands, and wherein the one or more components are configured to:
execute the flush command based at least in part on at least the threshold quantity of upcoming commands not including any write commands.

7. The memory system of claim 1, wherein the condition comprises the cache being full, and wherein the one or more components are configured to:
execute the flush command based at least in part on the cache being full.

8. The memory system of claim 1, wherein the one or more components are configured to:
set, based at least in part on receiving the flush command, a register at the memory system to a first value indicating one or more pending flush commands; and
set, based at least in part on executing the flush operation, the register to a second value indicating an absence of pending flush commands.

9. The memory system of claim 8, wherein the one or more components are configured to:
receive, after receiving the flush command and prior to executing the flush operation, a second flush command indicating for the memory system to perform a second flush operation on the cache of the memory system; and
refrain from executing the second flush operation based at least in part on the register being set to the first value.

10. The memory system of claim 1, wherein, to execute the flush operation, the one or more components are configured to:
perform a write operation at a non-volatile memory array of the memory system to transfer data stored in the cache to the non-volatile memory array.

11. A memory system, comprising:
a cache;
a non-volatile memory array;
a host interface configured to receive a synchronization command indicating for the memory system to transfer data from the cache to the non-volatile memory array; and
a controller coupled to the cache, the non-volatile memory array, and the host interface, the controller configured to transfer the data from the cache to the non-volatile memory array based at least in part on receiving the synchronization command and a condition associated with a transferring of data from the cache to the non-volatile memory array being satisfied.

12. The memory system of claim 11, wherein the controller is further configured to:
delay, for a duration after receiving the synchronization command, transferring the data based at least in part on the condition not being satisfied for the duration.

13. The memory system of claim 11, further comprising a register coupled to the controller and configured to:
store a first value to indicate a presence of one or more pending synchronization commands, the one or more pending synchronization commands corresponding to one or more received synchronization commands that have not been executed; or
store a second value to indicate an absence of pending synchronization commands.

14. The memory system of claim 13, wherein the controller is configured to:
store the first value in the register based at least in part on receiving the synchronization command; and
store the second value in the register based at least in part on transferring the data from the cache to the non-volatile memory array.

15. The memory system of claim 11, wherein the condition corresponds to whether the memory system:
receives, via the host interface, a command to perform an operation that includes transferring the data from the cache to the non-volatile memory array;
determines, by the controller, to perform a resource management operation that includes the transferring of the data from the cache to the non-volatile memory array; or
determines, by the controller, to perform an internal operation that includes the transferring of the data from the cache to the non-volatile memory array.

16. The memory system of claim 15, wherein the command to perform the operation corresponds to a power off notification, a power down command, a force unit access command, a reliable write command, or a stand-by command.

17. The memory system of claim 15, wherein the resource management operation corresponds to a mapping removal operation, a partition switching operation, a purge operation, a verification operation, a reset operation, a discard operation, or a sanitize operation.

18. The memory system of claim 15, wherein the internal operation corresponds to a checkpoint operation, a refresh operation, or a garbage collection operation.

19. The memory system of claim 11, wherein the condition comprises an operational condition associated with the memory system, wherein the operational condition corresponds to an idle time of the memory system being greater than a threshold or at least a threshold quantity of upcoming commands not including any write commands.

20. The memory system of claim 11, wherein the condition corresponds the cache being full.

21. A method, comprising:
receiving, from a host system, a flush command indicating for a memory system to perform a flush operation on a cache of the memory system;
determining whether to delay an execution of the flush operation based at least in part on whether a condition associated with executing flush operations at the cache is satisfied; and
executing the flush operation based at least in part on the condition being satisfied.

22. The method of claim 21, wherein:
determining whether to delay the execution of the flush operation comprises determining to delay the execution of the flush operation based at least in part on the condition not being satisfied; and
the method further comprises refraining from executing the flush operation for a duration based at least in part on the condition not being satisfied for the duration, wherein executing the flush operation occurs after the duration.

23. The method of claim 21, wherein the method further comprises:
executing a priority command after receiving the flush command, wherein the condition being satisfied is based at least in part on executing the priority command.

24. The method of claim 21, wherein the condition comprises an idle time of the memory system being greater than a threshold, and wherein the method further comprises:
executing the flush command based at least in part on the idle time of the memory system being greater than the threshold.

25. The method of claim 21, wherein the condition comprises at least a threshold quantity of upcoming commands not including any write commands, and wherein the method further comprises:
executing the flush command based at least in part on at least the threshold quantity of upcoming commands not including any write commands.
